(19) United States
(12) Patent Application Publication
(10) Pub. No.: US 2011/0018865 A1
(43) Pub. Date: Jan. 27, 2011

(54) METHOD FOR PROVIDING THREE DIMENSIONAL MAP SERVICE AND GEOGRAPHIC INFORMATION SYSTEM

(76) Inventor: Jae-Min Lee, Seoul (KR)

Correspondence Address: NIXON & VANDERHYE, PC, 901 NORTH GLEBE ROAD, 11TH FLOOR, ARLINGTON, VA, 22203, US

(21) Appl. No.: 12/673,838

(22) PCT Filed: Jun. 28, 2008
(86) PCT No.: PCT/KR08/03772

§ 371 Date: Feb. 17, 2010

(30) Foreign Application Priority Data
Aug. 17, 2007 (KR) 10-2007-0082813

(51) Int. Cl. G06T 15/00

(52) U.S. Cl. 345/419

(57) ABSTRACT

A method for providing a three dimensional (3D) map service and geographic information system (GIS) is provided. The method includes: establishing a search point P, a level L, an angle A, and a direction D for a 3D map service; calculating a viewpoint (x, y, z) with respect to the search point P based on the level L, angle A, and direction D; and providing a 3D map image of the search point P based on the calculated viewpoint (x, y, z).

### TECHNICAL FIELD

The present invention relates to a geographic information system, and more particularly, to a geographic information system and method for providing a three dimensional (3D) map service which provides map information, requested by a user, in a map type image in web environments.

### BACKGROUND ART

A geographic information system (hereinafter, referred to as “GIS”) refers to an information system which integrates attribute data related to geographic data and processes, and, in general, the GIS includes hardware, software, geographic information, and human resources which are used for effectively collecting, storing, updating, processing, analyzing, and outputting various types of geographic information.

As the GIS is combined with Internet technologies, Internet based map search technologies, which facilitate map searches, have become popular recently.

Through the GIS, location information such as longitude, latitude, and address of a location using GIS can be conveniently searched for, and the GIS provides the user with required geographic and map information in an appropriate map type image through query and analysis on spatial data stored in a relational database.

The most fundamental data required for GIS implementation is a digital map. The digital map, unlike a traditional paper map, is produced by analyzing and numerically editing various geographic data obtained from survey maps, aerial photographs and satellite images, whereupon the map is indexed and stored as a file.

As new web technologies such as Asynchronous JavaScript and XML (AJAX) have recently become available, GIS is being transformed from ActiveX control-based map services to image-based map services using pure web technologies such as JavaScript.

Image-based map services using pure web technologies have a number of merits, such as convenient use of steps and smooth interaction with users, including improved acceptance by the user since they do not require installation of control applications.

In the case of a two dimensional (2D) map service of a generic map service, a specific point pointed out by a user is displayed on a center of a result map screen.

FIG. 1 illustrates a user's request for ‘Kang Nam Station’ is represented in a 2D map service when a specific point is pointed out as ‘Kang Nam Station’. As illustrated in FIG. 1, geographic information about adjacent areas is represented in a 2D type based on the specific point ‘Kang Nam Station’.

However, various types of map services are inescapably required as performance and technology of hardware is highly improved.

In the case of a 3D map service, user's requests may include change of angles. In other words, in the case of a 2D map service, a user's view angle toward the 2D map is 90 degrees from a ground, however, in the case of a 3D map service, a user's view, that is a search result, may be changed by various angles and provided.

FIG. 2 illustrates a specific point is pointed out as ‘Kang Nam Station’ and a map service of 30 degrees is requested, and FIG. 3 illustrates a map service of 15 degrees is requested. In brief, geographic information about ‘Kang Nam Station’ is represented as the 3D map service of 15 degrees and the 3D map service of 30 degrees. As illustrated in FIG. 2, geographic information about adjacent areas of ‘Kang Nam Station’ is represented in a 3D map type according to the requested angle.

However, in existing 3D map services, it may be difficult for a user to obtain required geographic information since a specific point is represented in a center of a map screen regardless of a viewpoint the user requested. As illustrates in FIGS. 2 and 3, since the 3D map service provides a map screen by representing a specific point in a center, geographic information below the specific point may be shown in excessive detail, however geographic information above the specific point may not be identified.

### DISCLOSURE OF INVENTION

### Technical Goals

The present invention provides a method for providing a three dimensional (3D) map and geographic information system (GIS) which discloses a viewpoint search model for searching for a viewpoint of a 3D map image according to each angle.

The present invention also provides a method for providing a three dimensional (3D) map and geographic information system (GIS) which searches for a viewpoint capable of best viewing a map image and provide a specific point requested by a user.

### Technical Solutions

According to an aspect of the present invention, there is provided a method for providing a three dimensional (3D) map service including: establishing a search point P, a level L, an angle A, and a direction D for a 3D map service; calculating a viewpoint (x, y, z) with respect to the search point P based on the level L, angle A, and direction D; and providing a 3D map image of the search point P based on the calculated viewpoint (x, y, z).

According to another aspect of the present invention, there is provided a geographic information system (GIS) including: a database storing a 3D map image; a GIS server searching for the 3D map image stored in the map database and providing the retrieved 3D map image; and a database storing a 3D map image; a web server searching for a 3D map image of the search point via the GIS server when a search point P, a level L, an angle A and a direction D are established for a map service, searching for a viewpoint (x, y, z) with respect to the search point based on the search point P, level L, angle A and direction D, and providing the 3D map image of the search point P according to the retrieved viewpoint (x, y, z).

### ADVANTAGEOUS EFFECTS

The method for providing a three dimensional (3D) map service and geographic information system (GIS) system according to the present invention may provide a 3D map image corresponding to a search point of an optimal viewpoint by considering an angle and a direction of the 3D map with respect to a search point requested by a user.

According to the present invention, a distance between a search point and a viewpoint is determined according to an angle and a direction since an optimal viewpoint is searched for since an angle and a direction requested by a user are considered. That is, it is possible to provide a 3D map of an optimal viewpoint capable of viewing geographic information about a search point and adjacent areas around the search point.

Therefore, the present invention may provide a 3D map service which is visually improved and capable of identifying geographic information of a search point and adjacent areas of the search point.

### BRIEF DESCRIPTION OF DRAWINGS

FIG. 1 illustrates an example of a result of a request for a two dimensional (2D) map service which provides a 2D type map image with respect to a search point requested by a user;

FIGS. 2 and 3 illustrate examples of results of requests for a three dimensional (3D) map service which provides a 3D type map image with respect to a search point requested by a user, the request being made when the user requests the 3D image at different angles;

FIG. 4 illustrates a configuration of a geographic information system (GIS) for providing a 3D map image service according to the present invention;

FIG. 5 illustrates a virtual sphere which is adopted for searching for an optimal viewpoint according to an angle and a direction requested by a user, in the method for providing the 3D map service according to the present invention;

FIG. 6 illustrates all operations of a method for providing a 3D map service according to the present invention;

FIGS. 7 through 9 illustrate operations for searching for an optimal viewpoint with respect to a search point; and

FIGS. 10 and 11 illustrate results of a request for a map service which provides a 3D map image.

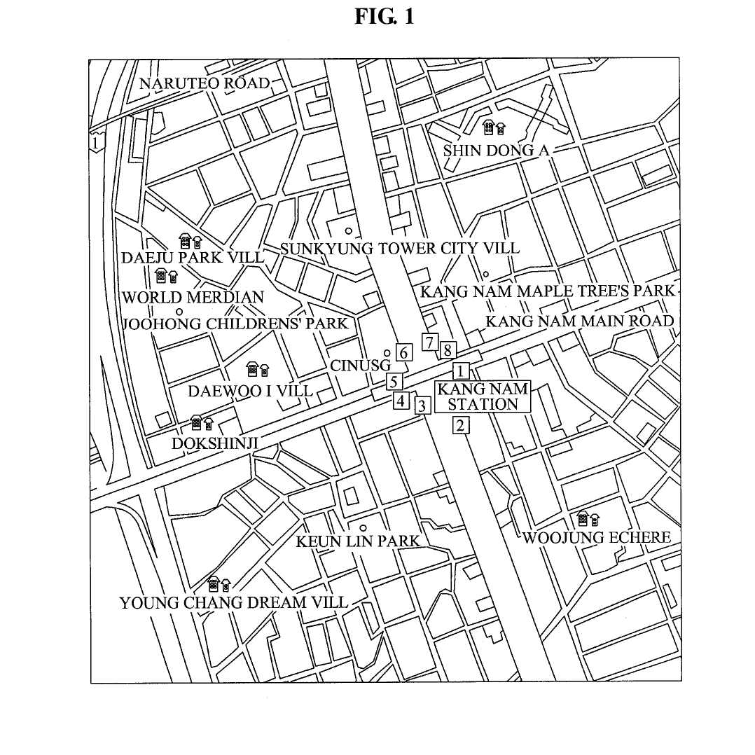

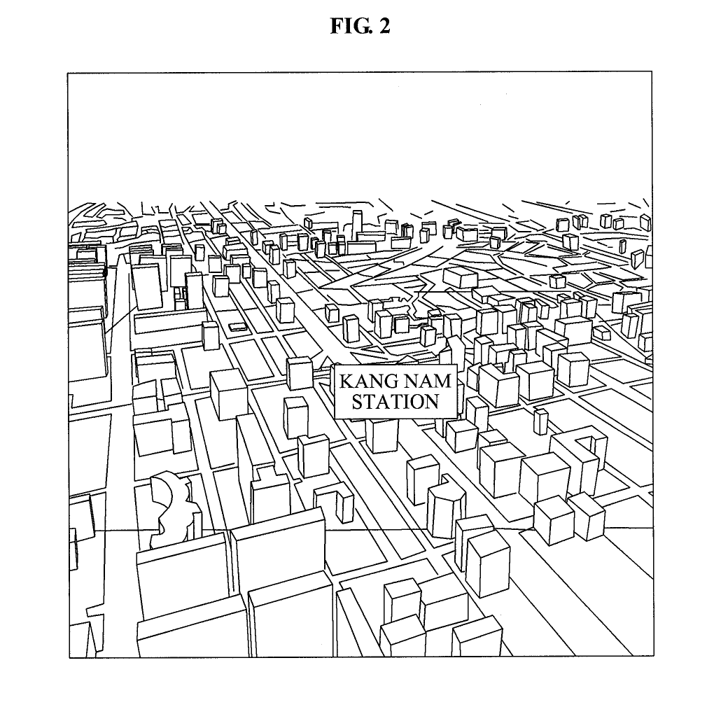

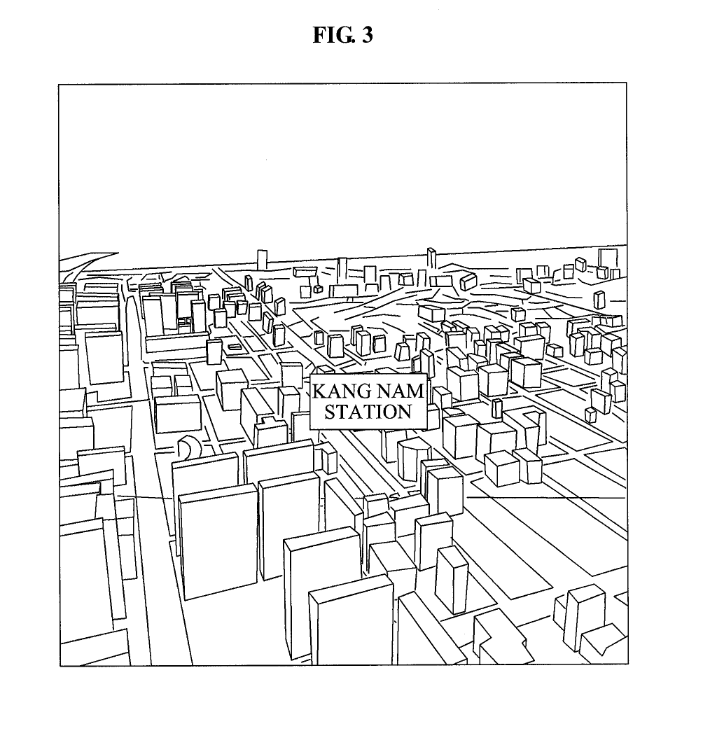

### BEST MODE FOR CARRYING OUT THE INVENTION

Hereinafter, a geographic information system (GIS) and a method for providing a three dimensional (3D) map service will be described in detail by referring to accompanied drawings according to exemplary embodiments of the present invention.

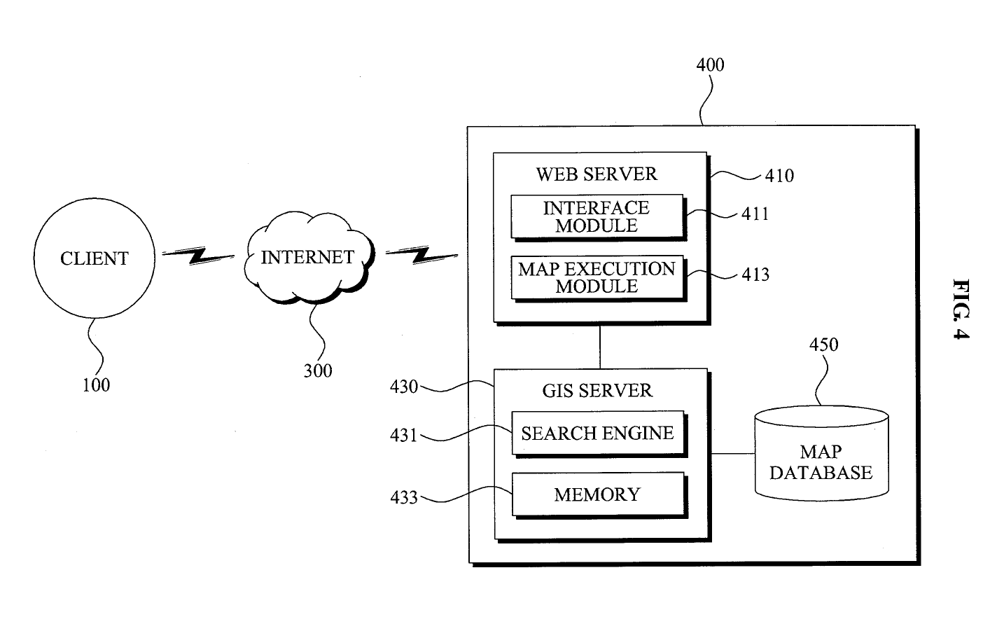

First, a configuration of the GIS according to the present invention will be described by referring to FIG. 4.

FIG. 4 illustrates a configuration of a GIS 400 of the present invention which is connected with a client via the Internet 300.

As illustrated in FIG. 4, a plurality of clients 100 are connected with the GIS 400 via the Internet 300. Users may connect with the GIS 400 via the plurality of clients 100 and search for a map about a required area. Here, the plurality of clients 100 basically may include a web browser, and use software such as a Plug-in, ActiveX Control, and JavaApplet. The plurality of clients 100 may include a mobile phone, a personal digital assistant (PDA), a navigator for a motor vehicle as well as personal computer (PC) capable of accessing to the Internet 300.

Users may input a level L, an angle A, and a direction D, which are reduced scales of a 3D map image, inputting a search point P where map image is to be requested after connecting to the GIS system 400.

As illustrated in FIG. 4, the GIS 400 may include a web server 410, GIS server 430, and map database 450.

The map database 450 may store index information of a map image corresponding to a map search item map image and a real map image of each area. The map image stored in the database 450 generally provides a 3D type image.

The GIS server 430 may include a search engine 431 and a memory 433 and may function as an interface between the web server 410 and the map database 450. The search engine 431 may extract a 3D map image required by a user from the map database 450 by receiving a search command for a map from the web server 410. The memory 433 may temporarily store the 3D map image being extracted from the database 450.

The web server 410 may receive a user's search request for a map from the plurality of clients 100, analyze the received user's search request for the map, and transmits the search command to the web browser of the plurality of clients 100. The retrieved 3D map image via the GIS server 430 is transmitted to the web browser of the client 100.

The web server 410 on the GIS system according to the present invention has a feature in that, a 3D map image may be provided with an optimal viewpoint (x, y, z) which is capable of best viewing a 3D map image of a search point P, requested by a user, from an angle A and a direction D which the user inputted.

For this, the web server 410 may include an interface module 411 and a map execution module 413.

The interface module 411 may control operations of information transmission/reception between the web server 410 and the clients 100, and may control processing operations regarding all commands inside.

The map execution module 413 may receive a 3D map image corresponding to the search point P requested by the user, calculate the optimal viewpoint (x, y, z) with respect to the search point P by considering an angle A and a direction D inputted by the user, and output the 3D map image based on the viewpoint (x, y, z).

Specifically, the map execution module 413 may extract a map image of a perpendicular viewpoint corresponding to the level L based on the search point P, and may include a height calculation unit calculating a height H0 of the perpendicular viewpoint of the map image and a viewpoint searching unit searching for the viewpoint (x, y, z) with respect to the search point P according to the angle A and direction D.

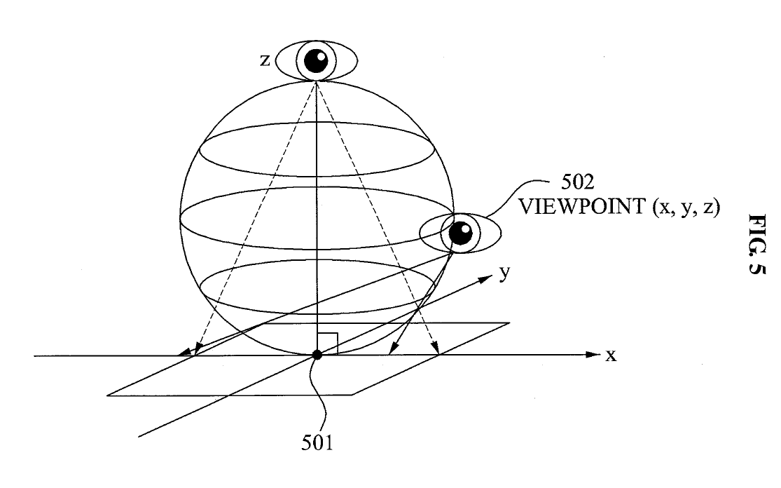

FIG. 5 illustrates a virtual sphere which is adopted for searching for an optimal viewpoint according to an angle and a direction requested by a user, in the method for providing the 3D map service according to the present invention.

As illustrated in FIG. 5, a search point P of the virtual sphere and the search point P is established as a starting point 501 of 3D coordinates, and another crossing point of a straight line and the virtual sphere is determined as an optimal view (x, y, z) 502. That is, coordinates of the viewpoint (x, y, z) 502 is determined on a surface of the virtual sphere according to the angle A and direction D, and a distance between the starting point 501 of the search point P and the viewpoint (x, y, z) is decreased as the angle A is decreased.

In particular, the viewpoint searching unit may include a first crossing point calculation unit, a height establishment unit, a second crossing point calculation unit, and a location establishment unit. The first crossing point calculation unit may calculate a crossing point of a first circle and a straight line on x/z coordinates, the first circle having a diameter of the perpendicular height H0 and the straight line passing through a starting point of the x/z coordinates with the angle A, the height establishment unit may establish a z coordinate value of the calculated crossing point (x, z) as a z coordinate value of the viewpoint (x, y, z) with respect to the search point P, the second crossing point calculation unit may calculate a crossing point (x, y) of a second circle having a diameter of the an x coordinate value of the calculated crossing point (x, z) on x/y coordinates and a straight line passing through a starting point of the x/y coordinates at the direction D, and the location establishment unit may respectively establish x and y coordinates of the crossing point (x, y) calculated in the second crossing point calculation unit as x and y coordinates of the viewpoint (x, y, z) with respect to the search point P.

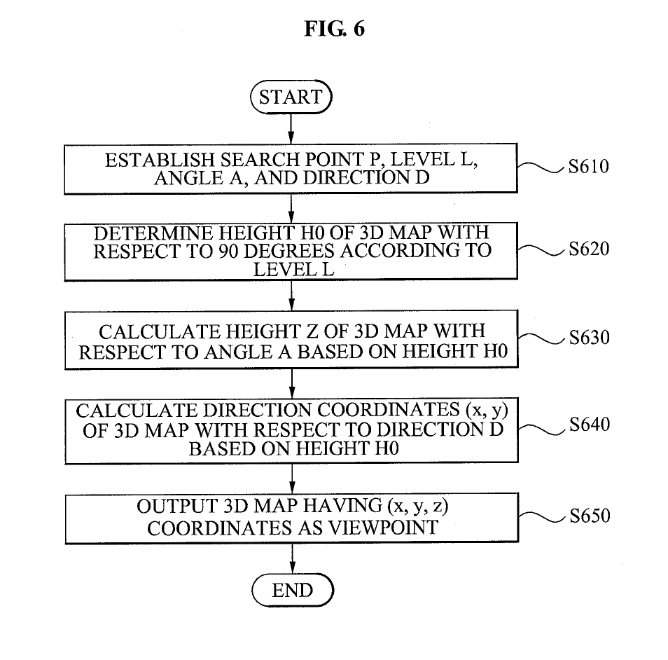

By referring to FIG. 6 and FIGS. 7 through 9, a method for providing a 3D map image in the web server 410 will be described in detail.

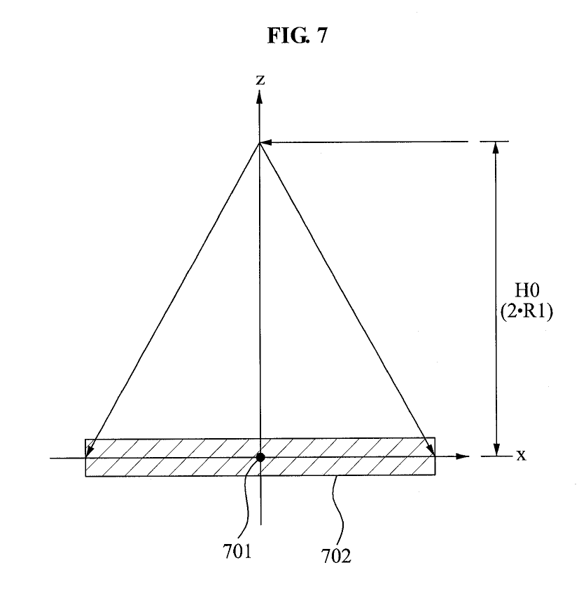

FIG. 6 illustrates all operations of a method for providing a 3D map service according to the present invention, and FIGS. 7 through 9 illustrate operations for searching for an optimal viewpoint with respect to a search point

In operation S610, a user may connect to a GIS and establish a search point P, a level L, an angle A, and a direction D for requesting for a map image. In this instance, the level L and direction D may be inputted from the user, or may use predetermined default values.

In operation S610, a viewpoint (x, y, z) of a 3D map image corresponding to the established search point P may be determined according to the level L, angle A, and direction D, and this will be described in detail.

In operation S620, with respect to 90 degrees, the GIS may determine a height H0 of the 3D map image according to the level L.

Specifically, as illustrated in FIG. 7, with respect to the perpendicular viewpoint, a map image 702 corresponding to the level L is extracted based on the search point P, and a height H0 of the extracted map image 702 of the perpendicular viewpoint may be calculated. In this instance, the height H0 may correspond to a z value which indicates a height of the viewpoint (x, y, z) viewed from a perpendicular angle.

In operations S630 and 640, the GIS may calculate the viewpoint (x, y, z) of the 3D map according to the angle A and direction D, requested by a user, based on the height H0 calculated in operation S620.

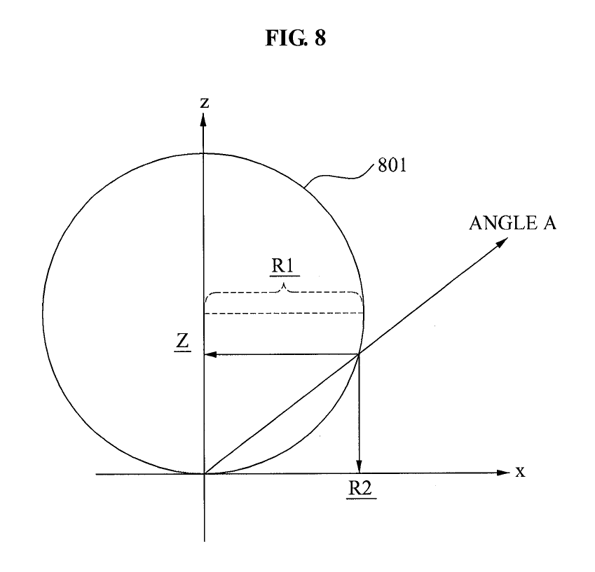

Specifically, in operation S630, the GIS may calculate a crossing point (x, z) of a first circle and a straight line on x/z coordinates consisting of an x axis and z axis as illustrated in FIG. 8, the first circle having a diameter (2*R1) of the perpendicular height H0 calculated in operation S620 and the straight line passing through a starting point of the x/z coordinates with the angle A. A z coordinate value of the crossing point (x, z) calculated in operation S630 may be established as a z coordinate value of the viewpoint (x, y, z) with respect to the search point P.

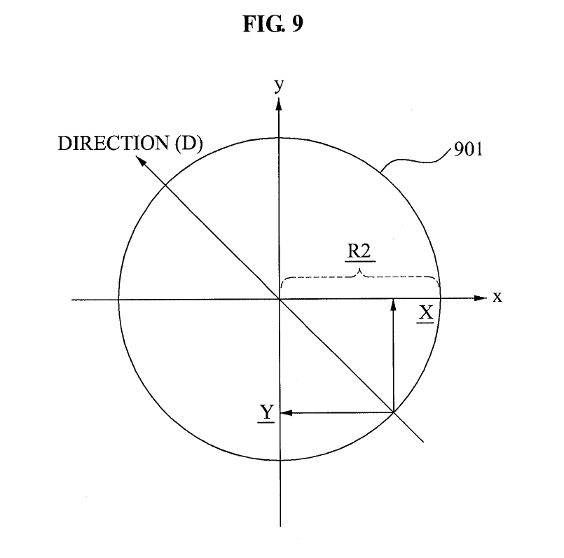

In operation S640, the GIS may calculate a crossing point (x, y) of a second circle and a straight line on x/y coordinates as illustrated in FIG. 9, the second circle having a diameter R2 of the x coordinate value of the calculated crossing point (x, z) calculated in operation S630 and the straight line passing through a starting point of the x/y coordinates at the direction D.

In operation S650, the GIS may output, with respect to the search point P requested by the user, a 3D map image having the viewpoint (x, y, z) established in operations S630 and 640.

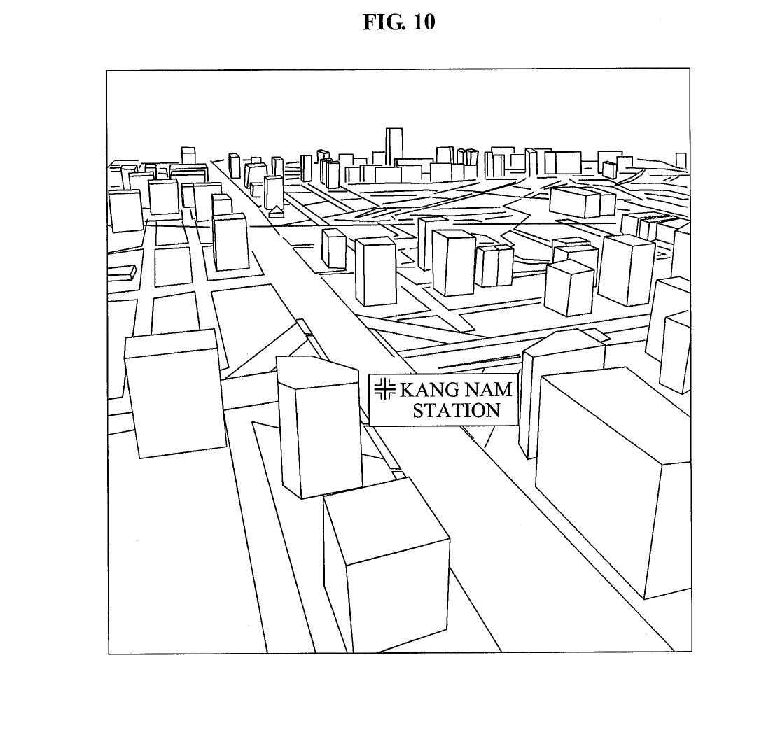

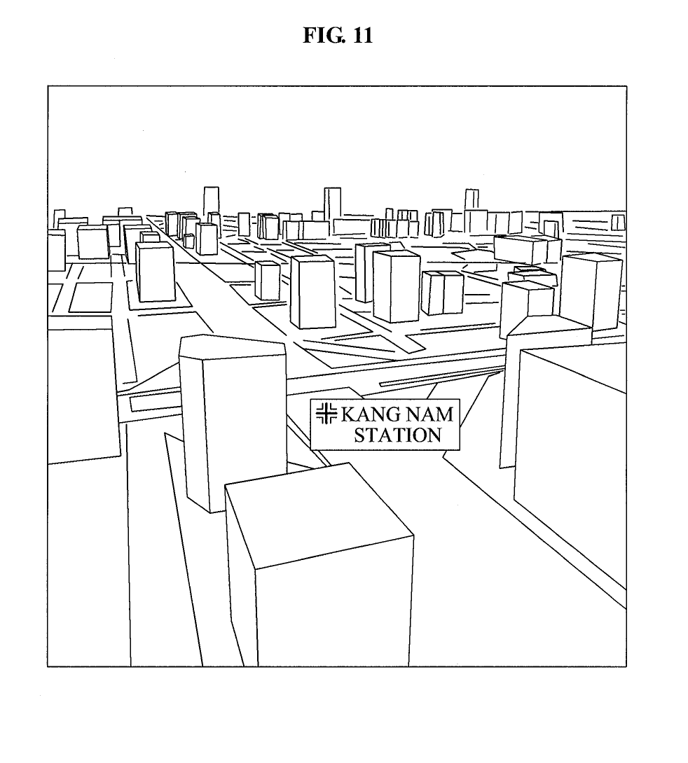

FIGS. 10 and 11 illustrate examples of screens of a 3D map service whose search point is ‘Kang Nam Station’, and FIG. 10 illustrates a map image whose search point is viewed from a 30 degrees angle, and FIG. 11 illustrates a map image whose search point is viewed from a 15 degrees angle.

Since the 3D map service of the present invention adopts a virtual sphere for searching for an optimal viewpoint according to an angle and a direction requested by a user, a distance between the search point P and the viewpoint is decreased as the angle A is decreased as illustrated. In particular, the present may easily identify geographic information over or below the search point P based on the search point in comparison to an existing 3D map service.

Therefore, the 3D map service according to the present invention may calculate a perpendicular height H0 when the search point P requested by the user is perpendicularly viewed, and may determine a viewpoint of a 3D map corresponding to the angle A and direction D on the virtual sphere having a diameter of the perpendicular height H0.

That is, the 3D map service of the present invention may determine an optimal viewpoint according to the angle A and direction D requested by the user and may provide a 3D map image of the corresponding viewpoint.

The method for providing a 3D map service according to the above-described exemplary embodiments may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. The media may also be a transmission medium such as optical or metallic lines, wave guides, and the like, including a carrier wave transmitting signals specifying the program instructions, data structures, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching.

Therefore, it is intended that the scope of the invention be defined by the claims appended thereto and their equivalents.

1. A method for providing a three dimensional (3D) map service, the method comprising:
establishing a search point P, a level L, an angle A, and a direction D for a 3D map service;
calculating a viewpoint (x, y, z) with respect to the search point P based on the level L, angle A, and direction D; and
providing a 3D map image of the search point P based on the calculated viewpoint (x, y, z).

2. The method of claim 1, wherein the calculating of the viewpoint (x, y, z) with respect to the search point P by considering the level, angle, and direction comprises:
extracting a map image of the search point P, a viewpoint of the map image being perpendicular which corresponds to the level L;
calculating a height H0 corresponding to the perpendicular point of the map image; and
calculating the viewpoint (x, y, z) with respect to the search point P according to the angle A and direction D by using a virtual sphere having a diameter of the calculated perpendicular height H0 of the map image.

3. The method of claim 2, wherein the calculating of the viewpoint (x, y, z) with respect to the search point according to the angle A and direction D by using the virtual sphere having the diameter of the perpendicular height H0 determines the viewpoint (x, y, z) on a surface of the virtual sphere according to the angle A and direction D.

4. The method of claim 3, wherein a crossing point of the virtual sphere and the search point P is established as a starting point of three dimensional coordinates (x, y, z) axes, and another crossing point of the virtual sphere and a straight line, having the search point P as a starting point, is determined as the viewpoint (x, y, z).

5. The method of claim 2, wherein the calculating of the viewpoint (x, y, z) with respect to the search point according to the angle A and direction D by using the virtual sphere having the diameter of the calculated perpendicular height H0 comprises:
calculating a crossing point (x, z) of a first circle and a straight line on x/z coordinates consisting of an x axis and z axis, the first circle having the diameter of the perpendicular height H0 and the straight line passing through a starting point of the x/z coordinates with the angle A;
establishing a z coordinate value of the calculated crossing point (x, z) as a z coordinate value of the viewpoint (x, y, z) with respect to the search point P;
calculating a crossing point (x, y) of a second circle and a straight line on x/y coordinates, the second circle having a diameter of the x coordinate value of the calculated crossing point (x, z) and the straight line passing through a starting point of the x/y coordinates at the direction D; and
respectively establishing x and y coordinates of the calculated crossing point (x, y) as x and y coordinates of the viewpoint (x, y, z) with respect to the search point P.

6. The method of claim 5, wherein a distance between the search point P and the viewpoint (x, y, z) is decreased as the angle A for the search point P is decreased.

7. At least one computer-readable storage medium storing instructions for implementing the method of claim 1.

8. A geographic information system (GIS), the system comprising:
a database storing a three dimensional (3D) map image;
a GIS server searching for the 3D map image stored in the map database and providing the retrieved 3D map image; and
a database storing a 3D map image;
a web server searching for a 3D map image of the search point via the GIS server when a search point P, a level L, an angle A and a direction D are established for a map service, searching for a viewpoint (x, y, z) with respect to the search point based on the search point P, level L, angle A and direction D, and providing the 3D map image of the search point P according to the retrieved viewpoint (x, y, z).

9. The system of claim 8, wherein the web server comprises:
a height calculation unit extracting a map image of the search point P, a viewpoint of the map image being perpendicular which corresponds to the level L, and calculating a height H0 of the perpendicular viewpoint of the extracted map image; and
a viewpoint searching unit searching for a viewpoint (x, y, z) with respect to the search point P according to the angle A and direction D.

10. The system of claim 9, wherein the viewpoint searching unit establishes a crossing point of a virtual sphere and the search point P as a starting point of three dimensional coordinates (x, y, z), and determines another crossing point of the virtual sphere and a straight line, having the search point P as a starting point, as the viewpoint (x, y, z).

11. The system of claim 9, wherein the viewpoint searching unit comprises:
a first crossing point calculation unit calculating a crossing point of a first circle and a straight line on x/z coordinates, the first circle having a diameter of the perpendicular height H0 and a straight line passing through the starting point of the x/z coordinates with the angle A;
a height establishment unit establishing a z coordinate value of the calculated crossing point (x, z) as a z coordinate value of the viewpoint (x, y, z) with respect to the search point P;
a second crossing point calculation unit calculating a crossing point (x, y) of a second circle and a straight line on x/y coordinates, the second circle having a diameter of the an x coordinate value of the calculated crossing point (x, z) and the straight line passing through a starting point of the x/y coordinates at the direction D; and
a location establishment unit respectively establishing x and y coordinates of the crossing point (x, y) calculated in the second crossing point calculation unit as x and y coordinates of the viewpoint (x, y, z) with respect to the search point P.
